(19) United States
(12) Patent Application Publication
(10) Pub. No.: US 2010/0116579 A1
(43) Pub. Date: May 13, 2010

(54) BENT AXIS HYDROMODULE WITH BOLT ON TRUNNION BEARING CARRIERS

(75) Inventors: Joseph Wright, Ames, IA (US); Doug Kardell, Grimes, IA (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 12/268,467

(22) Filed: Nov. 11, 2008

(51) Int. Cl. B60K 17/356

(52) U.S. Cl. 180/242

(57) ABSTRACT

A bent axis hydromodule that utilizes a bearing carrier assembly between the trunnion of a yoke and the frame of the bent axis hydromodule. The bearing carrier receives the trunnion and is secured to the frame by at least one fastening element that extends axially perpendicular to the trunnion axis that causes the fastening element preload force to be in the same direction as primary loading of that joint.

### BACKGROUND OF THE INVENTION

This invention relates to bent axis hydromodules. More specifically, this invention relates to attachment of a bearing carrier to the frame of a bent axis hydromodule.

Bent axis hydromodules are well known in the art. FIGS. 1 and 2 show prior art versions of bent axis hydromodules wherein FIG. 2 is shown in the U.S. Ser. No. 12/188,358 specification of which is incorporated herein. Current hydromodule designs use screws to react to trunnion forces in the shear direction as is shown in FIG. 1. These screw joints rely on friction in the shear plane to react to these trunnion forces. By relying on friction, only a small percentage of the screws preload force is available to react to trunnion forces. Consequently, a large number of screws have to be used in order to provide a bearing carrier that is able to handle the loads that result from the trunnion forces. As many as 21 screws can be used in a typical application in order to provide the desired force needed.

Therefore, a principal object of the present invention is to reduce the amount of parts of a bent axis hydromodule.

Yet another object of the present invention is to reduce the complexity of a bent axis hydromodule.

Another object of the present invention is to facilitate the assembly of a bent axis hydromodule while reducing package size and cost.

These and other objects, features, or advantages of the present invention will become apparent from the specification and claims.

### BRIEF SUMMARY OF THE INVENTION

A bent axis hydromodule that has a frame and a yoke with trunnions that are pivotably received by the frame for rotation of the yoke about a trunnion axis. A bearing carrier receives the trunnion and is secured to the frame by at least one fastening element that extends axially perpendicular to the trunnion axis.

### BRIEF DESCRIPTION OF THE DRAWINGS

FIG. 1 is a perspective view of a prior art bent axis hydromodule;

FIG. 2 is a perspective view of a prior art bent axis hydromodule;

FIG. 3 is an exploded partial perspective view of a bent axis hydromodule;

FIG. 4 is an exploded partial perspective view of a bent axis hydromodule; and

FIG. 5 is an exploded partial perspective view of a bent axis hydromodule.

### DETAILED DESCRIPTION OF THE PREFERRED EMBODIMENT

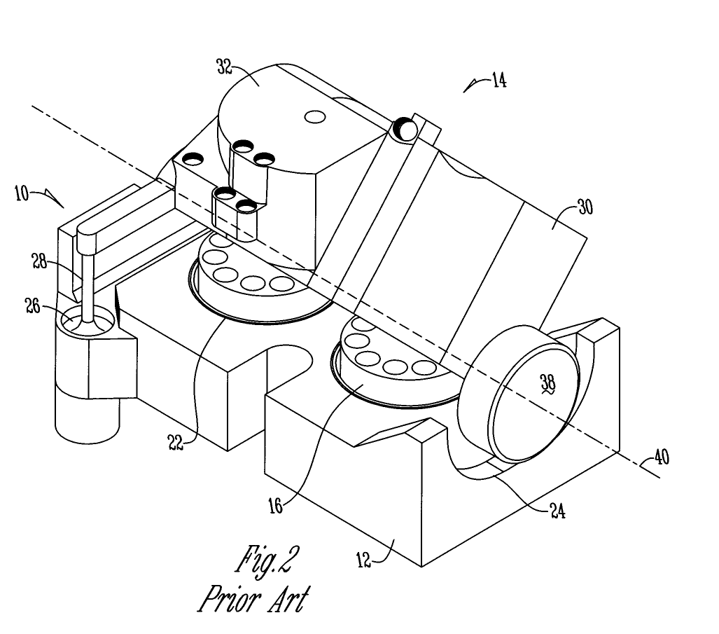

FIG. 2 shows a typical bent axis hydromodule 10. The hydromodule 10 is comprised of a frame 12 upon which a yoke 14 and rotating kits 16 having rotating kit shafts (not shown) are mounted.

The frame 12 includes opening 22 disposed therein for receiving the rotating kits 16 and receptacles 24 for receiving the yoke 14.

The yoke 14 as shown in FIG. 2 is a dual yoke with first and second yokes 30 and 32 being fluidly connected to one another. Each yoke 30 and 32 has internal porting (not shown) wherein the first and second rotating kit fluidly connection to one another. The yoke 14 additionally has trunnions, or journals 38, that are received by the receptacles 24 of frame 12 and bearing carrier 44 so that the yoke rotates about trunnion axis 40. As the yoke 14 rotates about the trunnion axis 40 volumetric displacement is altered thus affecting the operation of the rotating kits 16.

While FIG. 2 shows a bent axis dual yoke hydromodule the present application is directed toward any type of bent axis hydromodule. Thus, single yoke bent axis hydromodules are also envisioned for the present invention. Specifically, any bent axis type hydromodule or swashplate that utilizes trunnions 38 to provide a swinging, pivoting, or rotating type movement to actuate yokes, is contemplated without falling outside of the present disclosure.

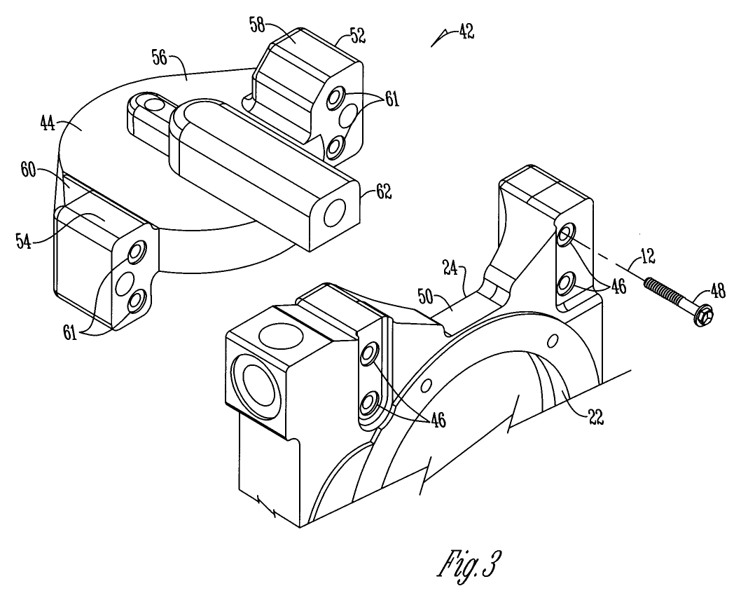

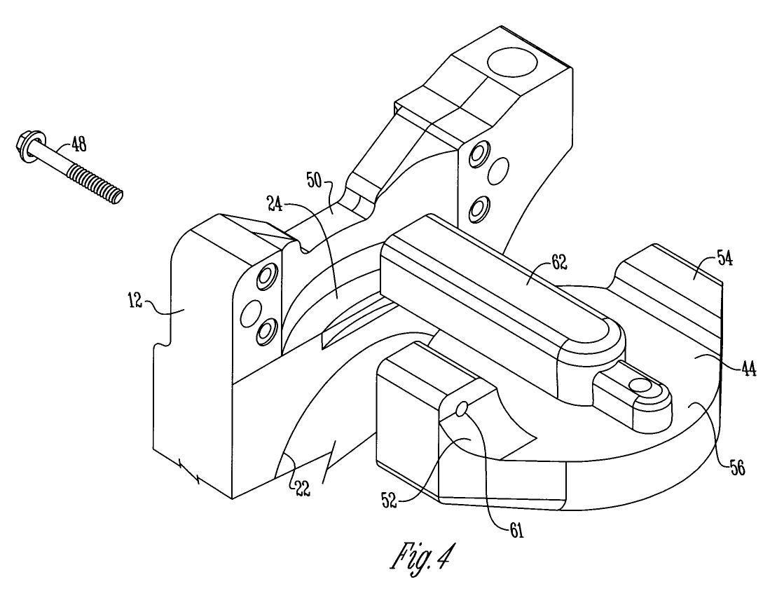

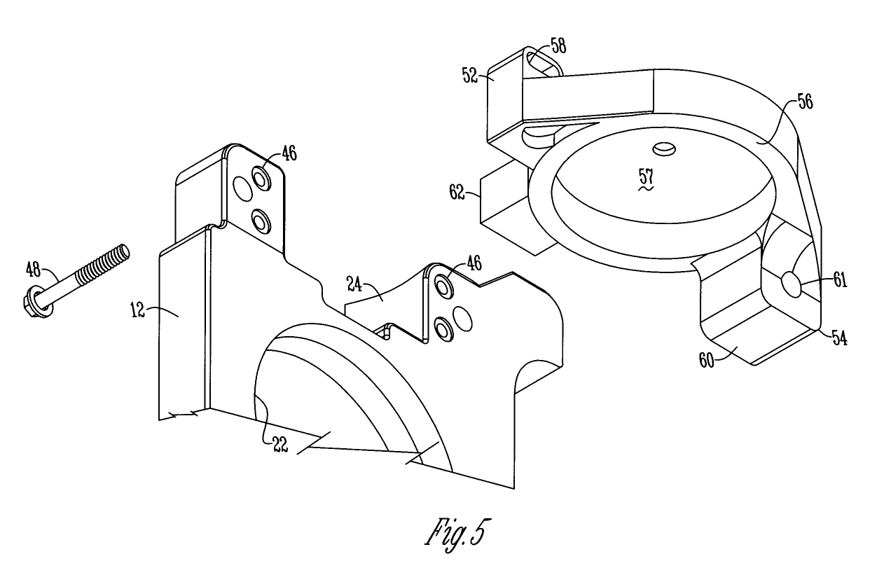

FIGS. 3-5 show a bearing carrier assembly 42. The bearing carrier assembly 42 includes the frame 12 and a bearing carrier 44. As shown in the figures the frame 12 has been modified to provide a plurality of openings 46 disposed therethrough for receiving a fastening element 48. The openings 46 are disposed through the width of the frame 12 extending parallel to opening 22. Additionally, adjacent the receptacle 24 is a female groove 50 for receiving the bearing carrier 44. The fastening element 48 in a preferred embodiment is a bolt that can be threaded into either frame 12 or bearing carrier 44; however, could be any other fastening element such as a screw or the like.

The bearing carrier 44 extends from a first end 52 to a second end 54 and has a body 56 therebetween. The body 56 includes a cavity 57 that receives the trunnion bearing at an end of the trunnion 38. At the first end 52 is a first flange 58 that has openings 46 disposed therethrough. The second end 54 similarly has a second flange 60 that also contains openings 61 disposed therethrough. In the embodiment as shown in FIG. 3 the first and second flanges 58 and 60 are offset. When in alignment the openings 61 of the first and second flanges 52 and 54 align with the openings 46 of the frame 12 wherein the fastening element 48 can be disposed through the openings 46 and 61 to secure the bearing carrier 44 to the frame 12.

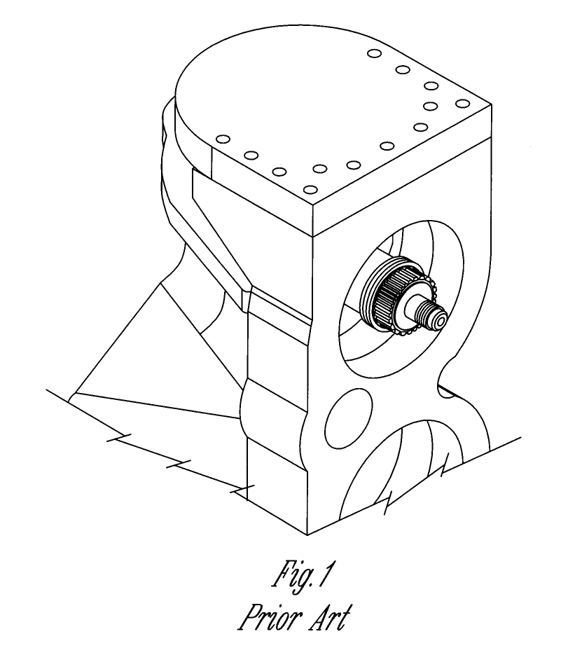

Typically, to withstand the forces applied by the trunnion 38 on the bearing carrier 44 only four fastening elements 48 are required for each trunnion. Thus, only eight fastening elements 48 are required per hydromodule 10. Specifically, because the fastening elements 48 extend axially perpendicular to the trunnion axis 40, the fastening element 48 preload force is in the same direction as the primary loading on the joint. As a result, the total number of fastening elements 48 is drastically reduced wherein typically the prior art design shown in FIG. 1 requires 21 fastening elements. One skilled in the art will understand that when referring to the axial direction that the fastening element 48 in the figures extends axially along its length that is in greater size than the radial extension of the fastening element 48. This axial extension, or plane, is a plane that is perpendicular to the trunnion axis 40 wherein in the prior art design seen in FIG. 1 this axial plane was parallel to the trunnion 38.

In operation, the interior cavity 57 receives the trunnion bearing. Once in place the openings 46 of the frame 12 align with the openings 61 of the bearing carrier 44 so that fastening elements 48 are disposed through both of the openings 46 and 59 to secure the bearing carrier 44 to the frame 12.

By placing the fastening element 48 axially perpendicular to the trunnion axis 40 the screw preload force is in the same direction as the primary loading in the joint making it more efficient use of the fastening elements 48. Consequently, the number of fastening elements 48 required is greatly reduced causing a reduced part count for the hydromodule. Additionally, by having this reduced part count there is reduced complexity, package size, and cost; all advantages provided over prior art bent axis hydromodules. Also, by reducing parts the assembly process is facilitated over that shown in the prior art. Consequently, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A bent axis hydromodule comprising:
a frame;
a yoke having a trunnion that is pivotably received by the frame for rotation of the yoke about a trunnion axis; and
a bearing carrier that receives the trunnion and is secured to the frame by at least one fastening element that extends axially perpendicular to the trunnion axis.

2. The bent axis hydromodule of claim 1 wherein the fastening element is a bolt.

3. The bent axis hydromodule of claim 1 wherein the fastening element is a screw.

4. The bent axis hydromodule of claim 1 wherein the bearing carrier has a first flange at a first end having openings therein for receiving fastening elements and a second flange at a second opposite end having openings therein for receiving fastening elements.

5. The bent axis hydromodule of claim 4 wherein the frame has openings therein that aligns with the openings on the first and second flanges.
